(19) United States
(12) Patent Application Publication
(10) Pub. No.: US 2023/0401970 A1
(43) Pub. Date: Dec. 14, 2023

(54) SYSTEMS AND METHODS FOR DISPLAYING INDIVIDUALIZED TUTORIALS

(71) Applicants: Eric R. GARCIA, Alhambra, CA (US); Regina M. GARCIA, Alhambra, CA (US)

(72) Inventors: Eric R. GARCIA, Alhambra, CA (US); Regina M. GARCIA, Alhambra, CA (US)

(21) Appl. No.: 18/334,044

(22) Filed: Jun. 13, 2023

Related U.S. Application Data
(63) Continuation-in-part of application No. 17/190,066, filed on Mar. 2, 2021.

(51) Int. Cl. G09B 5/06; G11B 27/00; A45D 44/00

(52) U.S. Cl. CPC G09B 5/065; G11B 27/007; A45D 44/005; A45D 2044/007

(57) ABSTRACT

A method for playing an instructional video tutorial is disclosed. The method includes providing to a display, data to present a video tutorial that includes a plurality of video segments. Each video segment is automatically looped, thereby improving instructional compliance. Upon a user selecting to advance to a next step, the next video segment is played and automatically looped to again, enable a user to better follow the instruction presented in each looping video segment. In one example, a playback speed may also be automatically altered in each successive playback loop to better enable a user to follow instruction.

### CROSS-REFERENCE TO RELATED APPLICATIONS

This application is a continuation-in-part of, and claims priority to, U.S. Non-Provisional patent application Ser. No. 17/190,066, filed Mar. 2, 2021, the disclosure of which is incorporated herein by reference in its entirety.

### TECHNICAL FIELD

This disclosure relates generally to video tutorial systems, and more particularly to systems and methods for displaying an individualized tutorials.

### BACKGROUND

Conventionally, application of cosmetics rely on user experience gained over trial and error, or expensive beauty schools or classes (online or in-person). A mirror is often used to aid in the application of cosmetics. Some users also utilize video tutorials to aid in the application of cosmetics. Such tutorials, however, are usually intended for entertainment purposes and not instruction, and further, are not individually tailored to the facial features of a particular user.

### SUMMARY

According to various aspects of the subject technology, a method for playing a video tutorial is provided. The method includes, at an electronic device with one or more processors and memory, wherein the device is in communication with a display, providing, to the display, data to present a video tutorial, the video tutorial comprising a plurality of segments. The method further includes automatically looping a first video segment; and during playback of the first video segment, receiving input that corresponds to a request to display a second video segment. The method further includes in response to receiving the input that corresponds to the request to display the second video segment, automatically looping the second video segment.

Another aspect of the present disclosure relates to an electronic device that is in communication with a display. The device includes one or more processors and memory storing one or more programs for execution by the one or more processors, the one or more programs including instructions for providing, to the display, data to present a video tutorial, the video tutorial comprising a plurality of segments; automatically looping a first video segment; during playback of the first video segment, receiving input that corresponds to a request to display a second video segment; and in response to receiving the input that corresponds to the request to display the second video segment, automatically looping the second video segment.

Yet another aspect of the present disclosure relates to a non-transitory computer readable storage medium storing one or more programs, the one or more programs having instructions, which, when executed by an electronic device that is in communication with a display, cause the device to provide, to the display, data to present a video tutorial, the video tutorial comprising a plurality of segments; automatically loop a first video segment; during playback of the first video segment, receive input that corresponds to a request to display a second video segment; in response to receiving the input that corresponds to the request to display the second video segment, automatically loop the second video segment.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The embodiments herein may be better understood by referring to the following description in conjunction with the accompanying drawings in which like reference numerals indicate identical or functionally similar elements. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a perspective view of a smart mirror, in accordance with various aspects of the subject technology;

FIG. 2 illustrates a perspective cutaway view of a smart mirror, in accordance with various aspects of the subject technology;

FIG. 3 illustrates a rear view of a smart mirror, in accordance with various aspects of the subject technology;

FIG. 4 illustrates a cross section view of a smart mirror, in accordance with various aspects of the subject technology;

FIG. 5A illustrates an exemplary display of a smart mirror, in accordance with various aspects of the subject technology;

FIG. 5B illustrates an exemplary display of a smart mirror, in accordance with various aspects of the subject technology;

FIG. 6A illustrates an exemplary process for identifying reference points of facial features of a user, in accordance with various aspects of the subject technology;

FIG. 6B illustrates an exemplary process for identifying a symmetry of facial features of a user, in accordance with various aspects of the subject technology;

FIG. 6C illustrates an exemplary process for identifying a symmetry of facial features of a user, in accordance with various aspects of the subject technology;

FIG. 6D illustrates an exemplary process for identifying a symmetry of facial features of a user, in accordance with various aspects of the subject technology;

FIG. 6E illustrates an exemplary process for generating an individualized cosmetic instruction, in accordance with various aspects of the subject technology;

FIG. 6F illustrates an exemplary process for generating an individualized cosmetic instruction, in accordance with various aspects of the subject technology;

FIG. 6G illustrates an exemplary process for generating an individualized cosmetic instruction, in accordance with various aspects of the subject technology;

FIG. 7A illustrates an exemplary cosmetic routine template that may be utilized to generate an individualized cosmetic program, in accordance with various aspects of the subject technology;

FIG. 7B illustrates an exemplary cosmetic routine template that may be utilized to generate an individualized cosmetic program, in accordance with various aspects of the subject technology;

FIG. 8A illustrates an exemplary process for applying an individualized cosmetic program using an intelligent feedback system, in accordance with various aspects of the subject technology;

FIG. 8B illustrates a detailed view of a first rendering of an exemplary cosmetic instruction generated in accordance with an individualized cosmetic program, in accordance with various aspects of the subject technology;

FIG. 8C illustrates a detailed view of a second rendering of an exemplary cosmetic instruction generated in accordance with an individualized cosmetic program, in accordance with various aspects of the subject technology;

FIG. 8D illustrates an exemplary process for applying an individualized cosmetic program using an intelligent feedback system, in accordance with various aspects of the subject technology;

FIG. 8E illustrates an exemplary process for applying an individualized cosmetic program using an intelligent feedback system, in accordance with various aspects of the subject technology;

FIG. 8F illustrates an exemplary process for applying an individualized cosmetic program using an intelligent feedback system, in accordance with various aspects of the subject technology;

FIG. 8G illustrates an exemplary graphical user interface for displaying an individualized video tutorial, in accordance with various aspects of the subject technology;

FIG. 9 illustrates an example network environment utilizing an individualized cosmetic and intelligent feedback system, in accordance with various aspects of the subject technology;

FIG. 10 illustrates a conceptual block diagram of data structures utilized in an individualized cosmetic and intelligent feedback system, in accordance with various aspects of the subject technology;

FIG. 11 illustrates an example method for generating an individualized cosmetic program, in accordance with various aspects of the subject technology; and

FIG. 12 illustrates an example of a system configured for generating an individualized cosmetic program, in accordance with various aspects of the subject technology.

### DETAILED DESCRIPTION

In the following detailed description, numerous specific details are set forth to provide a full understanding of the subject technology. It will be apparent, however, to one ordinarily skilled in the art that the subject technology may be practiced without some of these specific details. In other instances, well-known structures and techniques have not been shown in detail so as not to obscure the subject technology.

Conventionally, successful application of cosmetics rely on user experience gained over lengthy trials and many errors. While a mirror provides some aid in assessing application of cosmetics onto the skin of a user, conventional mirrors merely provide a reflection of the user and nothing more. Conventional mirrors are incapable of guiding a user through careful application of cosmetics to ensure that the final application is pleasing and desirable to the user. And while some users may utilize video tutorials to aid in their application of cosmetics, such tutorials lack feedback and are not individually tailored to the facial features of a particular user. Many struggle in achieving a smooth, flawless application that appears symmetrical regardless of a particular user's asymmetrical features (e.g., a droopier eye compared to the other eye, a sagging cheek compared to the other cheek, a higher eyebrow compared to the other eyebrow). As a result, the final application of the cosmetics may result in misapplication of the cosmetics or aesthetics that are not ideal to that particular user. Accordingly, there is a need for a system that is configured to generate an individualized cosmetic program or routine, and further configured to guide the user in applying the cosmetics using intelligent feedback to ensure proper application of the cosmetics for an aesthetically pleasing result with little waste in materials, time and effort.

The disclosed technology addresses the need in the art for an intelligent cosmetic application system that utilizes facial scanning to identify symmetry (or asymmetry) of facial features for generation of an individualized cosmetic program, and that further utilizes dynamic feedback to guide a user in proper application of cosmetic materials thereby ensuring a desirable and pleasing final application. The intelligent cosmetic application system may augment a reflection of the user by, for example, displaying a dynamic outline to define an area on the skin for application of a cosmetic material. A color, shade, shape and other parameters necessary to achieve a desired application may also be displayed to guide the user in applying the cosmetic material. Should misapplication be detected, an intervention in the form of an audio or visual instruction or alarm may be evoked to correct the application of the cosmetic material. The user may further choose a cosmetic routine from a plurality of available templates, designs, or styles, and may further preview selections through an augmented reflection of the user. In addition, a communication interface allows the intelligent cosmetic application system to communicate with a portable electronic device or mobile device, as well as third-party platforms (e.g., social media, marketplaces, etc.) to convey product recommendations, treatment reminders, and share images or videos of a user's cosmetic application.

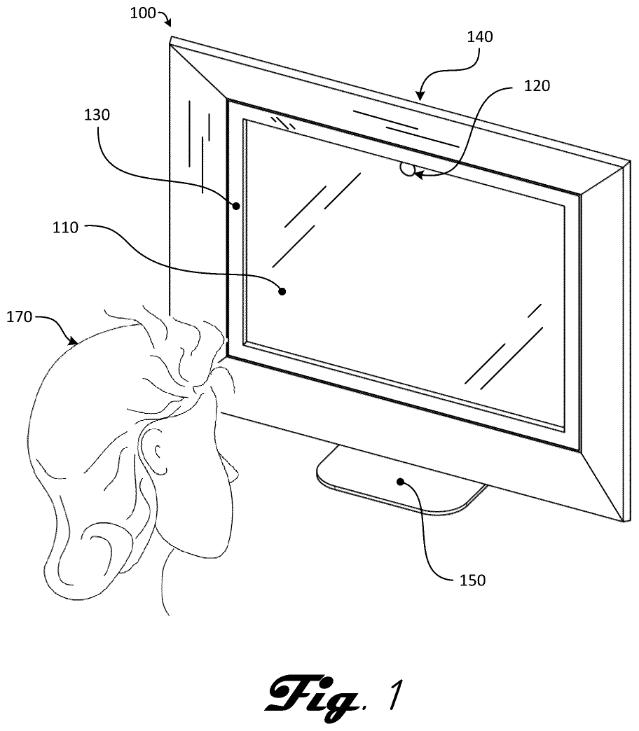

FIG. 1 illustrates a perspective view of a smart mirror 100, in accordance with various aspects of the subject technology. The smart mirror 100 includes a mirror 110 having a reflective surface on one side for showing a reflection of a user 170, and a transparent surface on an opposite side for allowing images or videos to be viewable through the mirror 110. The mirror 110 may be a one-way mirror or a two-way mirror. The smart mirror 100 also includes an image capture device 120 that is configured to capture images of the user 170 for scanning of facial features, as discussed further below. The image capture device 120 may comprise a digital camera, an image sensor (e.g., charge-coupled device (CCD), active-pixel sensor (CMOS sensor), etc.), thermal imaging device, radar, sonar, infrared sensor, depth sensor, optical sensor, or other image capture device or sensor as would be known by a person of ordinary skill in the art. The smart mirror 100 may also include a decorative frame 140 and a base 150 for supporting the smart mirror 100.

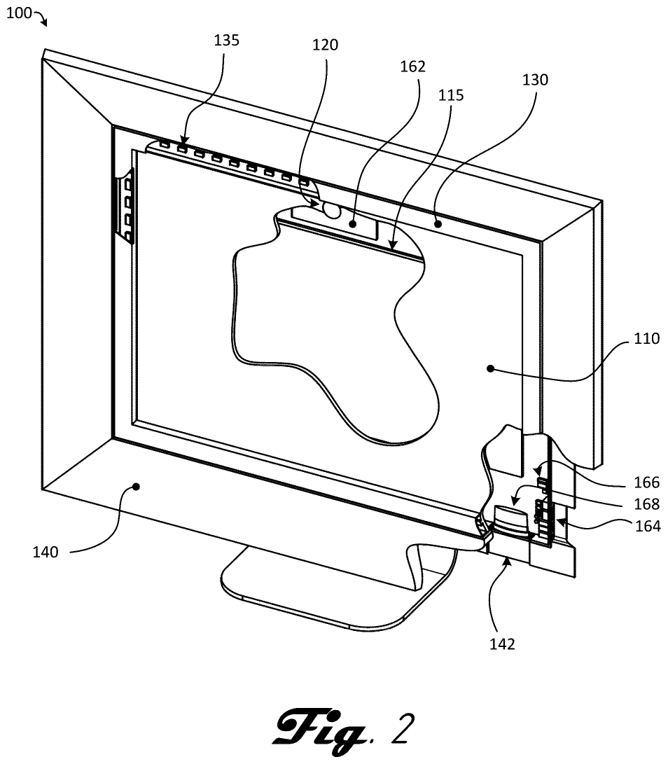

FIG. 2 illustrates a perspective cutaway view of the smart mirror 100, in accordance with various aspects of the subject technology. The smart mirror 100 includes a display 115 disposed proximate to the transparent surface of the mirror 110. As discussed further below, the display 115 is configured to augment a reflection of the user. The display 115 may comprise a liquid crystal display (LCD), light-emitting diode (LED) display, plasma (PDP) display, quantum dot (QLED) display, or other display as would be known by a person of ordinary skill in the art. The display 115 may further comprise a touch interface for receiving user input.

The smart mirror 100 may also include a light 130 that is configured to illuminate the user. The light 130 may comprise a plurality of LEDs 135 arranged around a periphery of the mirror 110. The plurality of LEDs 135 may utilize diffusers to soften light emitted by the plurality of LEDs. In some aspects, a color temperature and/or intensity of emitted light may be adjusted based on a color temperature and/or intensity of ambient light to ensure that cosmetic coloring and application guidance is accurate. The color temperature and/or intensity of ambient light may be detected using a photodetector or other light sensors as would be understood by a person of ordinary skill in the art. For example, where an intensity of ambient light is low, an intensity of light emitted by the plurality of LEDs 135 may be increased to ensure sufficient lighting for cosmetic application. As another example, where an intensity of ambient light is high, an intensity of light emitted by the plurality of LEDs 135 may be decreased where ambient light is sufficient for cosmetic application. In another example, where a color temperature of ambient light is warm (e.g., less than 3000K), a color temperature of light emitted by the plurality of LEDs 135 may be adjusted to 5000K or more (e.g. daylight) to ensure that color schemes for the cosmetic application are accurate.

The smart mirror 100 also includes a processor 162. The processor 162 receives image data generated by the image capture device 120. In one aspect, the processor 162 is configured to process the image data to assess symmetry or asymmetry of facial features of a user (e.g., eyebrows, eyes, nose, mouth, etc.). In one aspect, the processor 162 is also configured to identify a skin color and/or skin condition of the user. The processor 162 is configured to generate an individualized cosmetic treatment program based on the symmetry or asymmetry of the facial features of the user, as well as the skin color and/or skin condition of the user. The processor 162 may also be configured to cause the display 115 to display a cosmetic instruction (e.g., an outline denoting an area for cosmetic application) to aid the user in applying a cosmetic material onto their face or body.

Specifically, the processor 162 may be configured to process image data to identify an area on the user for cosmetic application and to denote that area with the cosmetic instruction (e.g. outline) via an augmented reflection of the user to aid the user in applying the cosmetic material in the proper location and shape. In other words, the processor 162 causes the display 115 to display the outline, in this example, within the user's reflection on the mirror 110. The processor 162 is further configured to track the user's body or face so that the outline tracks movement or motion of the user's reflection thereby ensuring a fluid and dynamic display of the outline to the user, thereby further aiding the user in applying the cosmetic material onto their face or body. As a user's body or face moves, the image capture device 120 captures the orientation of the user's body or face and the processor renders and distorts the outline so that when displayed by the display 115 in the mirror 110, it appears to the user as if the outline is disposed directly on the user's body or face.

The processor 162 may also be configured to monitor application of cosmetic material to detect misapplication of the cosmetic material, and if detected, to cause an intervention to correct the misapplication. The intervention may be an auditory tone, auditory message, video, image or textual message displayed on the display 115 that is configured to inform the user that the cosmetic application is being applied incorrectly and to encourage the user to take remedial action to correct the misapplication.

The smart mirror 100 may also include ports 164 (e.g., USB ports) for charging a rechargeable battery (not shown), connecting peripherals, or for facilitating a network connection. The smart mirror 100 may also include a communication interface 166 for wirelessly communicating with a mobile device or network. In one example, the communication interface may be utilized to convey a cosmetic product recommendation or cosmetic application reminder to the user via their mobile device. In another example, the communication interface may convey images or videos of the user's cosmetic applications to their social media. The smart mirror 100 may also include a speaker 168 for providing auditory feedback (e.g., sounds, voice commands, voice instructions, music, etc.) to the user. The smart mirror 100 may utilize sound ports 142 to channel the auditory feedback to the user. In one aspect, the sound ports 142 are configured to enhance the audio signals via reflection through the decorative frame 140.

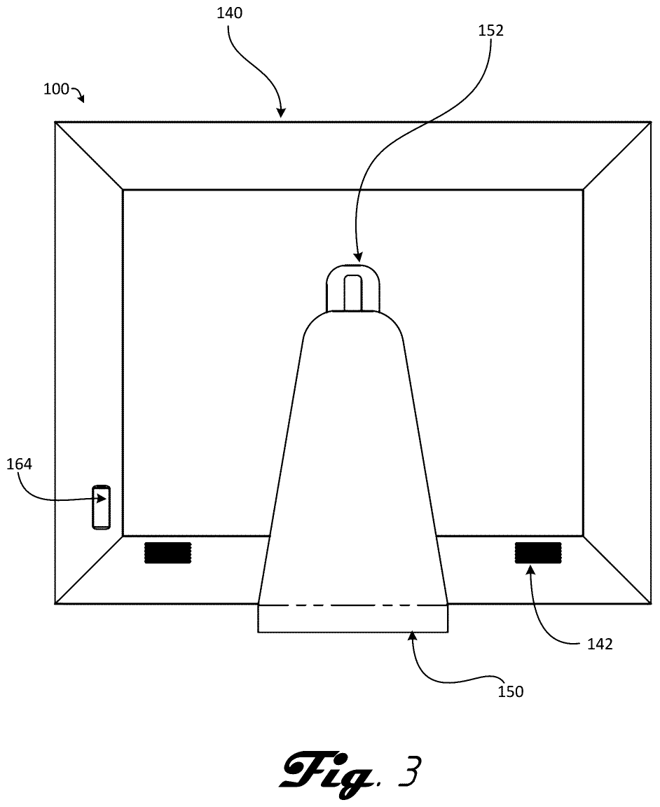

FIG. 3 illustrates a rear view of the smart mirror 100, in accordance with various aspects of the subject technology. The smart mirror 100 may utilize an adjustable base 150 that is capable of moving in a vertical direction via a channel mount 152 that enables the smart mirror 100 to move vertically up or down. The base may also accommodate rotational motion about a pivot to further aid in ergonomics and comfort.

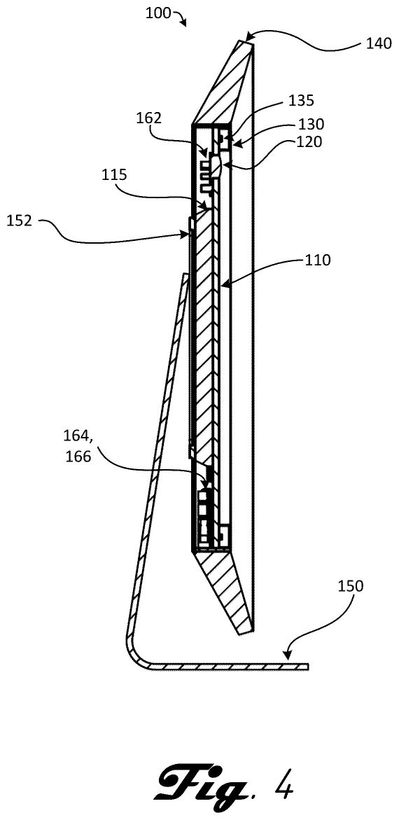

FIG. 4 illustrates a cross section view of the smart mirror 100, in accordance with various aspects of the subject technology. As shown, the display 115 is disposed proximate to the mirror 110, within the decorative frame 140 and behind a reflective surface of the mirror 110. The image capture device 120 is disposed through the mirror 110, but in other examples, could be disposed behind the mirror 110 (similarly to the display 115). The light 130 and LEDs 135 are shown along a periphery of the mirror 110, but it is understood that other arrangements of the light 130 and LEDs 135 are contemplated without departing from the scope of the disclosure.

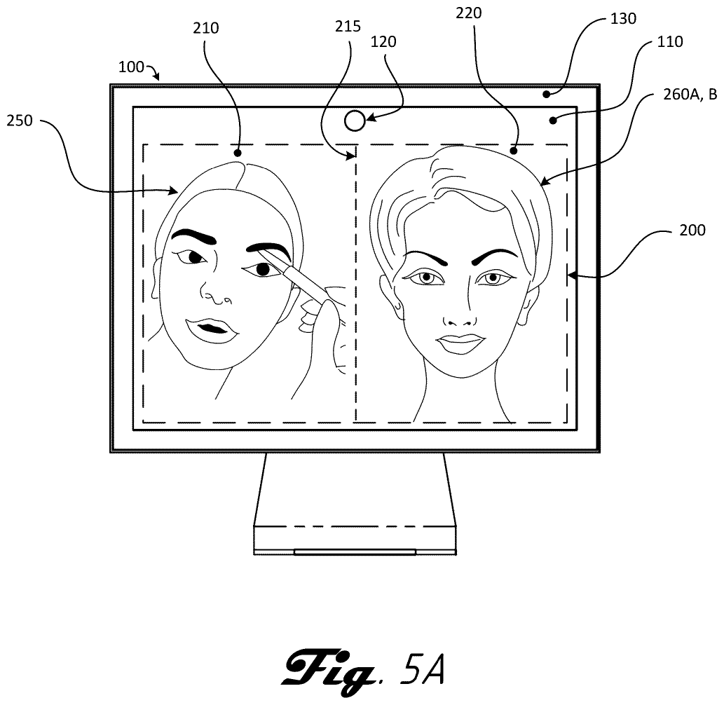

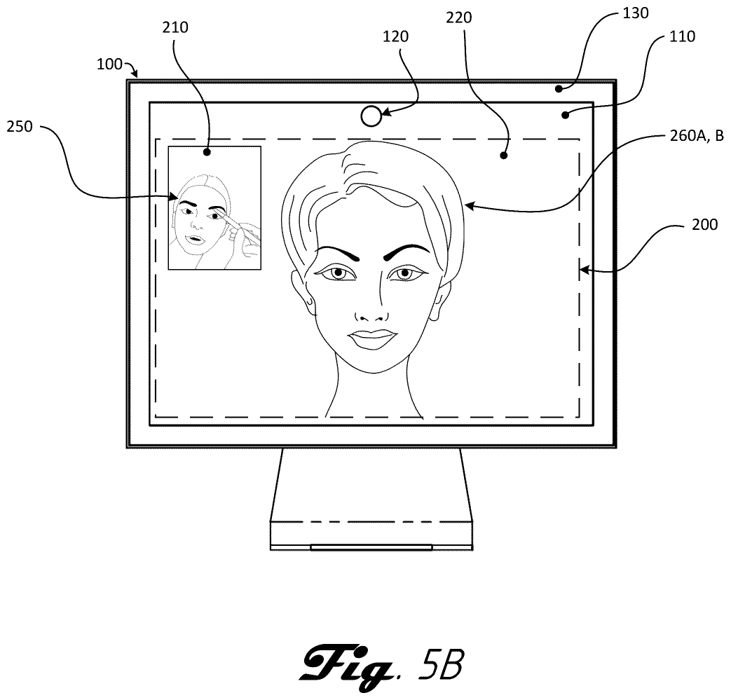

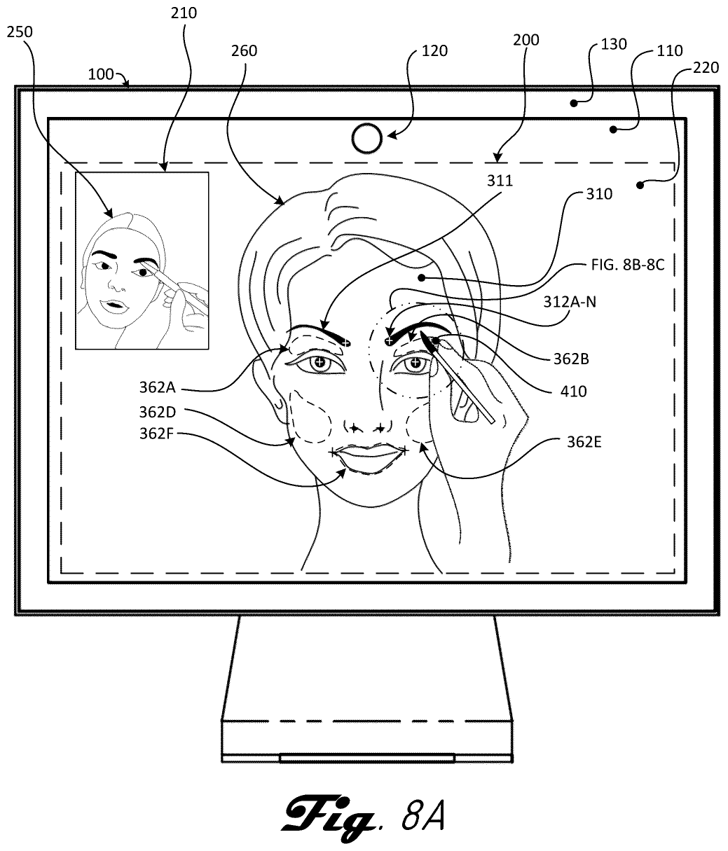

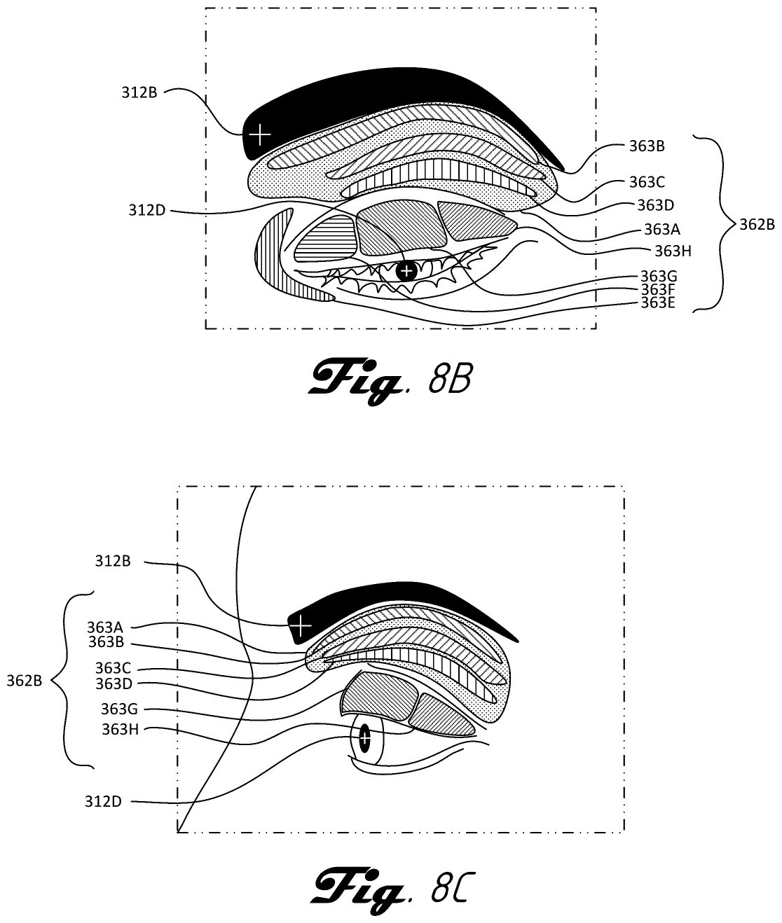

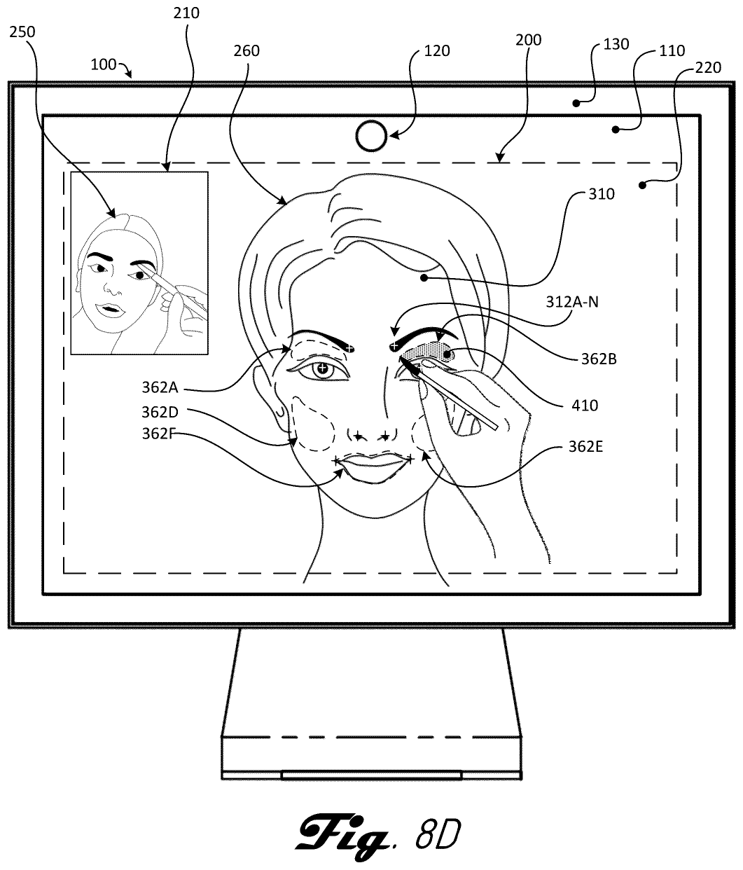

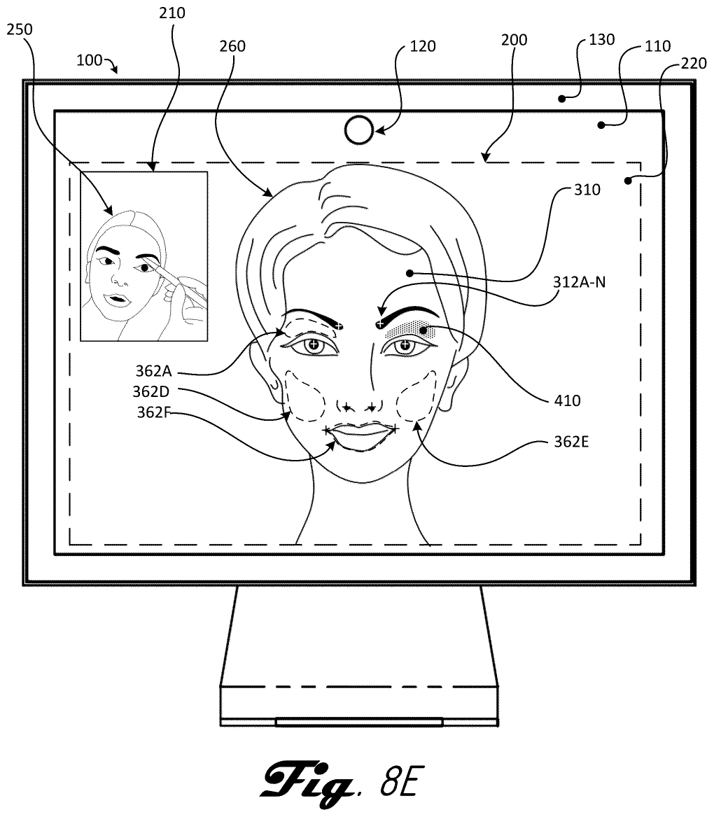

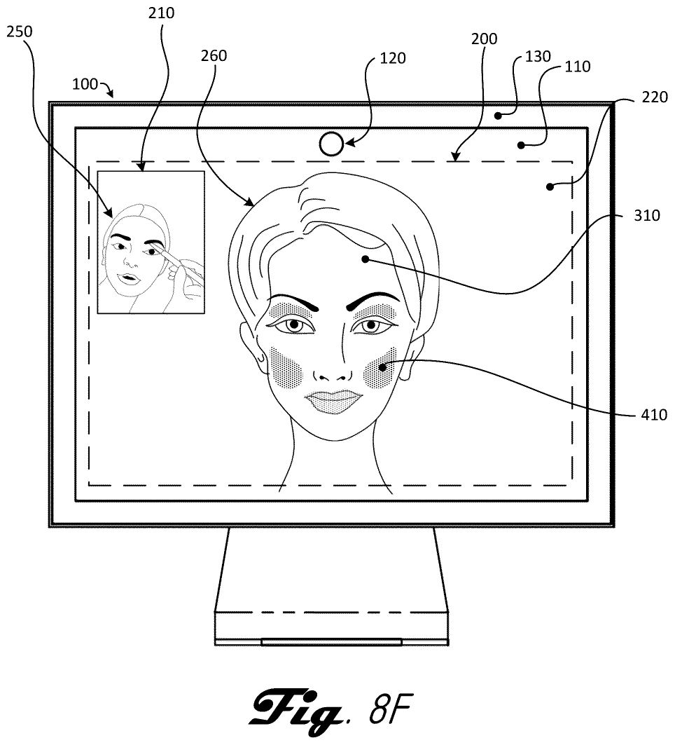

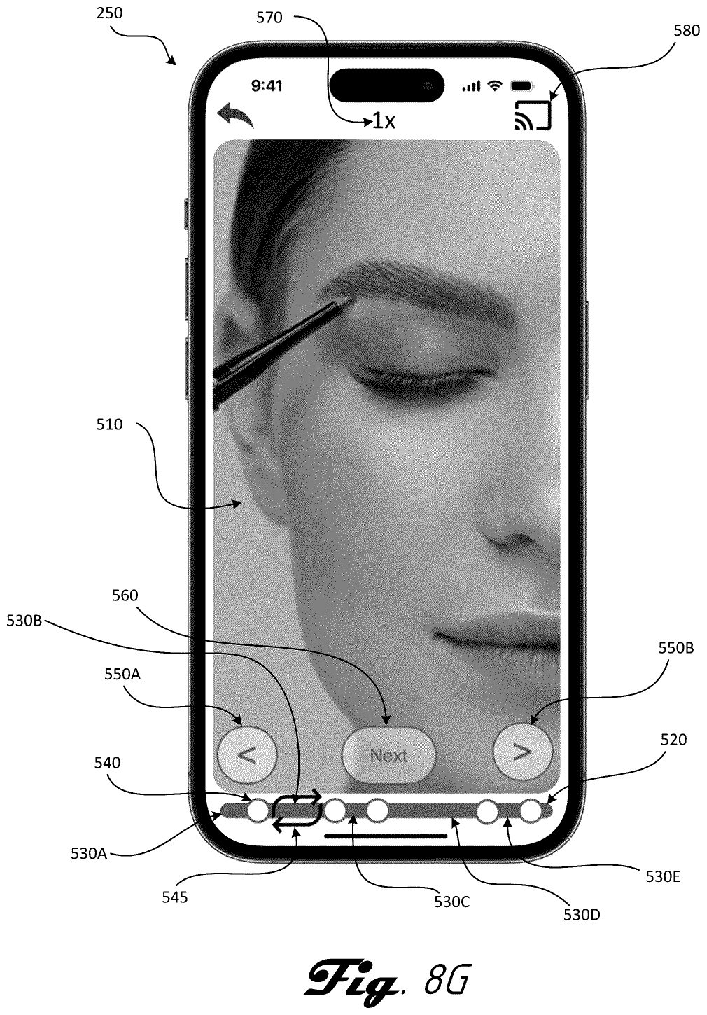

FIG. 5A illustrates an exemplary display layout 200 of the smart mirror 100, in accordance with various aspects of the subject technology. In one example, a display layout 200 of the smart mirror 100 may be partitioned by a divider 215 into two regions, a first region 210 and a second region 220. The first region 210 displays a tutorial 250 generated by the display 115 (not shown). The tutorial 250 may be an instructional video guiding the user on proper application of a cosmetic material. In one aspect, the second region 220 augments a reflection 260A of the user by using the display 115 (not shown), as discussed further below with reference to FIGS. 8A-8F, to augment instructional elements onto the reflection of the user.

In an alternative embodiment, the smart mirror 100 may utilize the display 115 (as shown in FIGS. 2 and 4) to render a live augmented video 260B of the user (as captured by the image capture device 120) in the second region 220, without utilizing a reflection of the user. In this example, the reflective properties of the mirror 110 are not utilized, and rather, the display 115 renders a live video of the user, including any instructional elements as described in FIGS. 8A-8F, into the live video to aid the user in applying cosmetics.

FIG. 5B illustrates another exemplary display layout 200 of the smart mirror 100, in accordance with various aspects of the subject technology. In this example, the second region 220 utilizes a larger area of the display layout 200 compared to the first region 210. The second region 220 augments a reflection 260A of the user by using the display 115 (not shown), as discussed further below with reference to FIGS. 8A-8F, to augment instructional elements onto the reflection of the user. The first region 210 displays the tutorial 250. In an alternative embodiment, the smart mirror 100 may utilize the display 115 (as shown in FIGS. 2 and 4) to render a live augmented video 260B of the user (as captured by the image capture device 120) in the second region 220, without utilizing a reflection of the user. In this example, the reflective properties of the mirror 110 are not utilized, and rather, the display 115 renders a live video of the user, including any instructional elements as described in FIGS. 8A-8F, into the live video to aid the user in applying cosmetics.

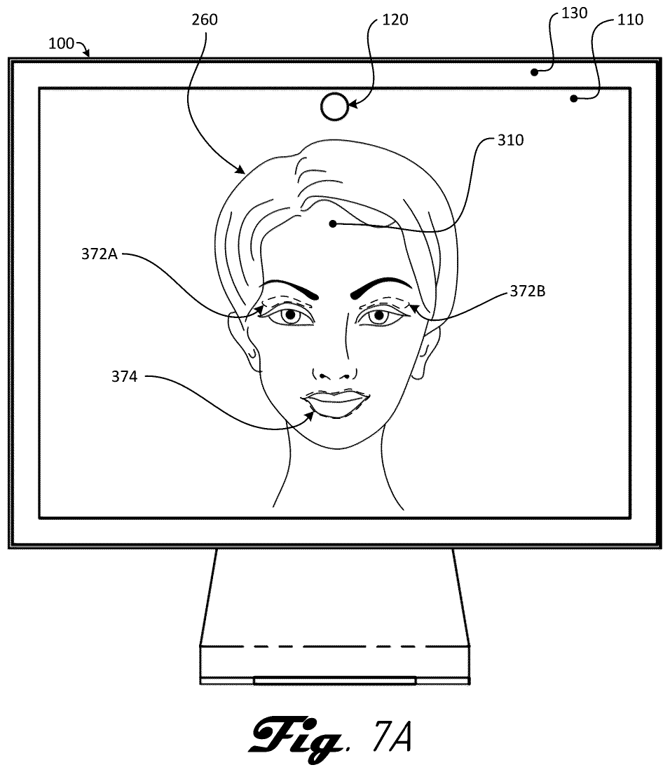

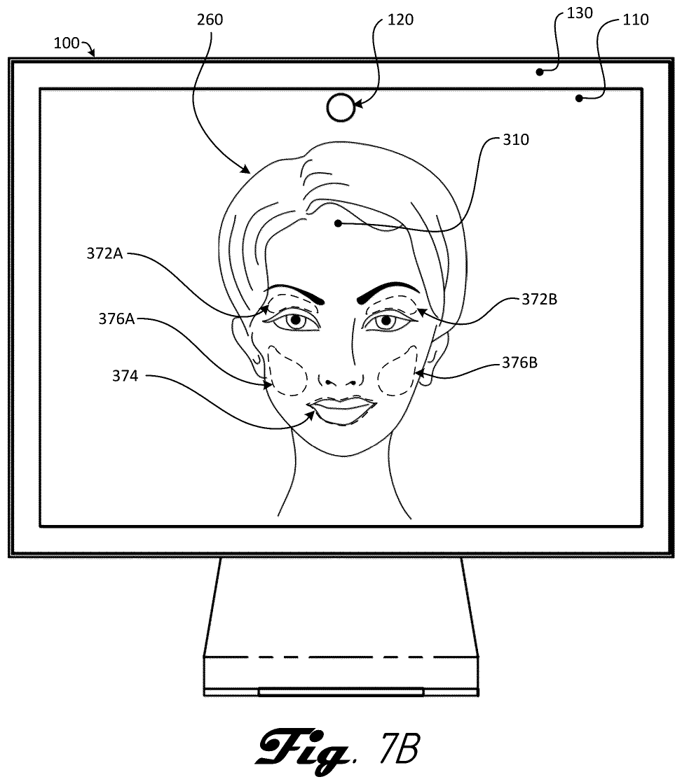

The display layout 200 may also define an area that is configured to receive user input via a touch interface, such as through use of a resistive touchscreen, capacitive touchscreen, surface acoustic wave touch screen, infrared touchscreen, optical imaging touchscreen, acoustic pulse recognition touchscreen, or any other touch interfaces as would be known by a person of ordinary skill in the art. The display layout 200 may receive a selection from the user of a desired cosmetic routine, skin care routine, or health screening routine, as discussed further below with reference to FIGS. 7A and 7B.

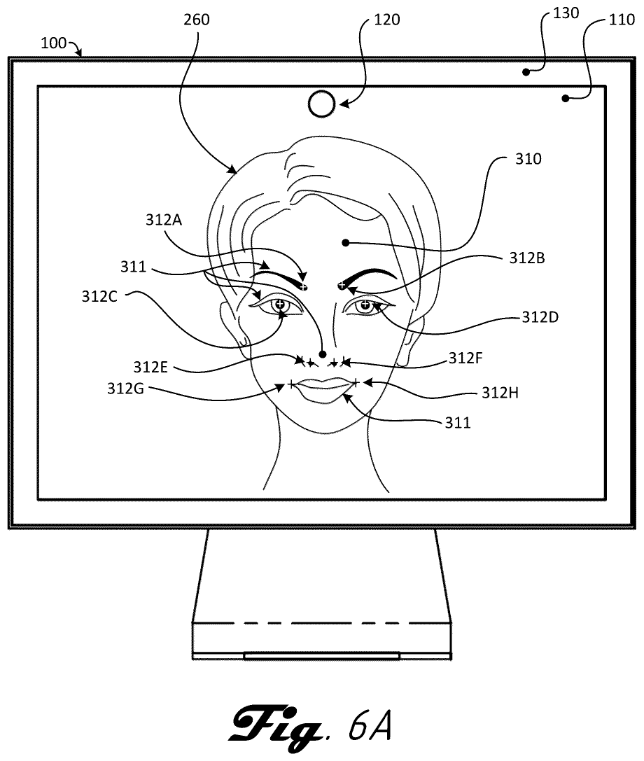

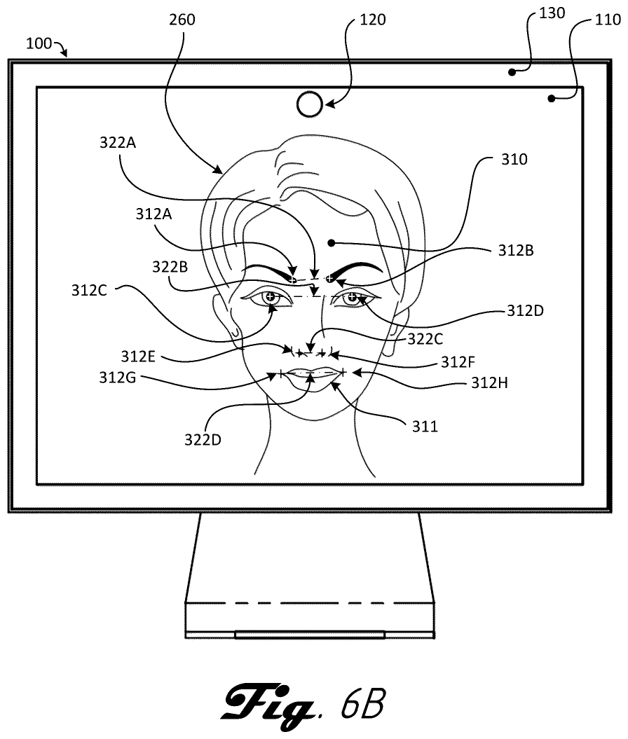

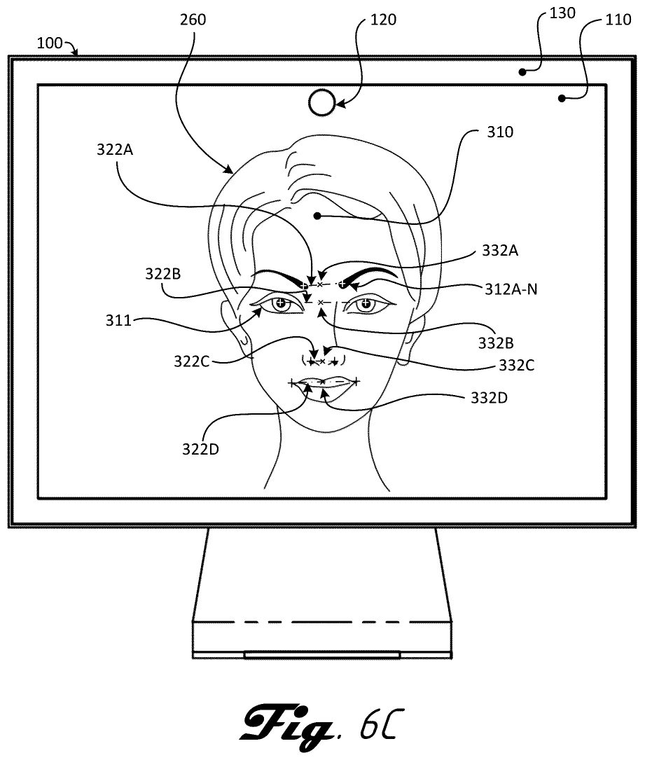

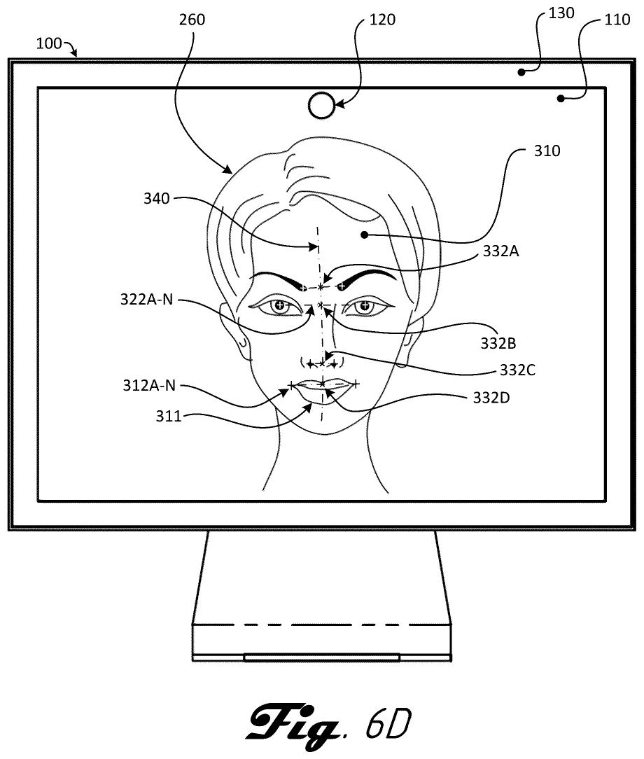

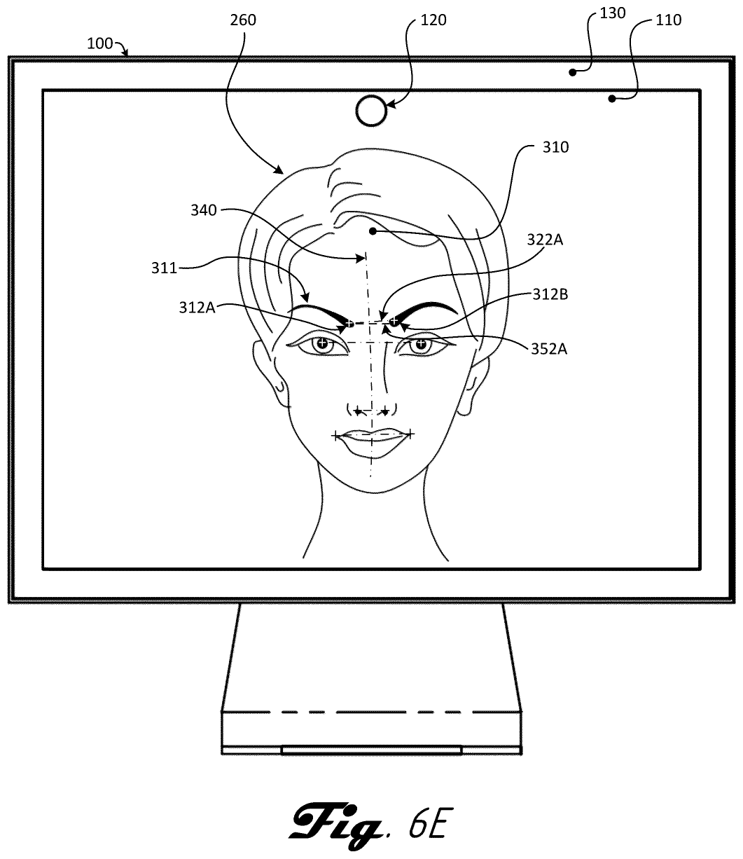

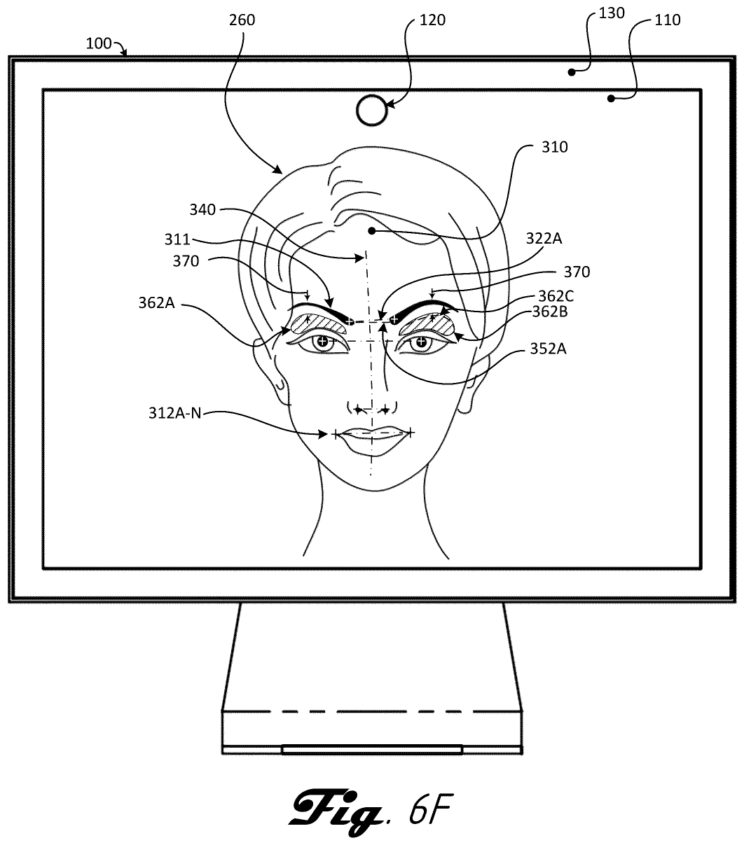

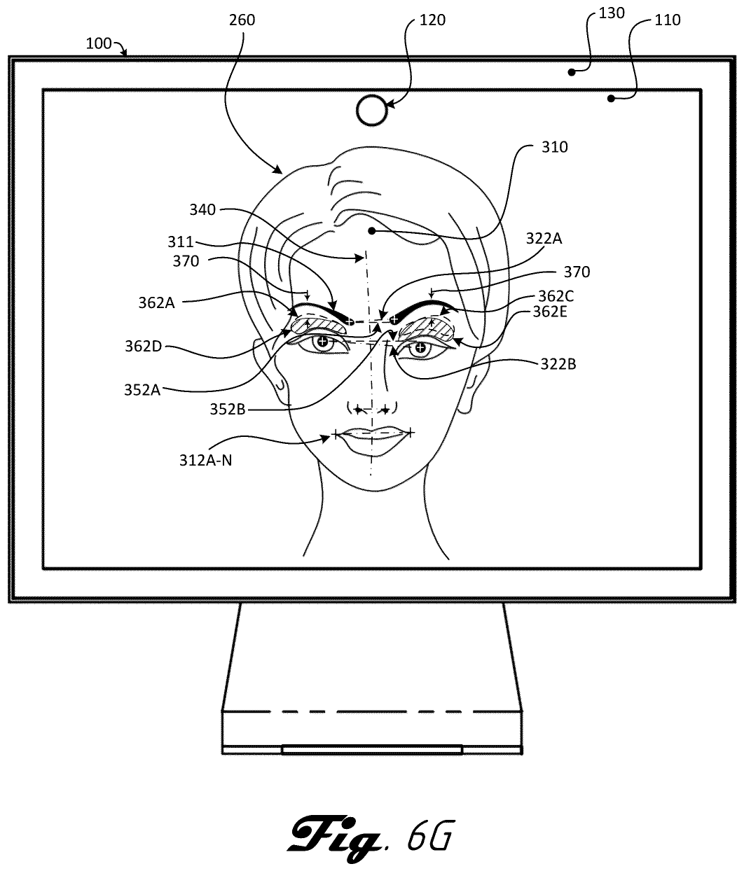

FIGS. 6A-6D illustrate an exemplary process for identifying reference points 312A-N of facial features 311 of a user 260 in accordance with various aspects of the subject technology. Referring to FIG. 6A, in one aspect, image data captured by the image capture device 120 is analyzed by the processor to identify a plurality of reference points 312A-N corresponding to facial features 311 of the user 260. For example, the image data may be analyzed or processed to identify eyebrows, eyes, nose, and/or mouth of the user 260 and to correlate reference points 312A-N for each facial feature 311. For example, the right (from perspective of the user) eyebrow may be assigned reference point 312A and the left eyebrow may be assigned reference point 312B. The right eye may be assigned reference point 312C and the left eye may be assigned reference point 312D. A right nostril of the nose may be assigned reference point 312E and a left nostril may be assigned reference point 312F. A right corner of the mouth may be assigned reference point 312G and a left corner of the mouth may be assigned reference point 312H.

In addition, the image data may be analyzed to identify a skin condition 310 of the user 260. The skin condition 310 may include a tone or color of the skin, discoloration, or disorder. The skin condition 310 may be utilized by the processor to further customize a cosmetic treatment program (e.g., cosmetic application routine, skin care routine, etc.) based on the user's skin condition 310. For example, if the user's skin color is darker in tone, the cosmetic treatment program will be generated based on a particular color theory and disclaim those colors that will not work well with the user's skin tone or color, or otherwise blend well with the user's skin.

Referring to FIG. 6B, reference lines 322A-N extending across corresponding reference points 312A-N may be used to identify an axis of symmetry of the facial features 311 of the user 260. For example, reference line 322A corresponding to an alignment of the eyebrows may extend from reference point 312A to reference point 312B. Reference line 322B corresponding to an alignment of the eyes may extend from reference point 312C to reference point 312D. Reference line 322C corresponding to an alignment of the nostrils may extend from reference point 312E to reference point 312F. Reference line 322D corresponding to an alignment of the mouth may extend from reference point 312G to reference point 312H.

Referring to FIG. 6C, midpoint references 332A-N may be used to identify an axis of symmetry of the facial features 311 of the user 260. For example, midpoint reference 332A may be disposed at an approximate midpoint of the reference line 322A corresponding to an alignment of the eyebrows. Midpoint reference 332B may be disposed at an approximate midpoint of the reference line 322B corresponding to an alignment of the eyes. Midpoint reference 332C may be disposed at an approximate midpoint of the reference line 322C corresponding to an alignment of the nostrils. Midpoint reference 332D may be disposed at an approximate midpoint of the reference line 322D corresponding to an alignment of the mouth.

Referring to FIG. 6D, an axis of symmetry 340 may be disposed through the midpoint references 332A-N to assess a symmetry of the facial features 311 of the user 260. The axis of symmetry 340 divides the facial features 311 of the user 260 to enable an assessment and comparison of a shape and location of each of the facial features 311 from one side of the axis of symmetry 340 to the other side of the axis of symmetry 340. For example, the location of the right eye may be compared to the location of the left eye, with respect to the axis of symmetry 340, to identify a degree of asymmetry associated with the right and left eye in terms of their respective locations, as well as shape. In addition, the assessment may identify instances where an eyelid may be more droopier than the other eyelid, and so on. In another example, the location of right eyebrow may be compared to the location of the left eyebrow, with respect to the axis of symmetry 340, to identify a degree of asymmetry associated with the right and left eyebrows in terms of their respective locations, as well as shape. As shown in FIG. 6D, the location of the left eyebrow is higher when compared to the location of the right eyebrow, as demonstrated by the reference line 322A having a slope. As a result, an area of skin between the left eyebrow and the left eye is larger than the area of skin between the right eyebrow and the right eye. As another example, the location of right nostril may be compared to the location of the left nostril, with respect to the axis of symmetry 340, to identify a degree of asymmetry associated with the right and left nostrils. In yet another example, the location of right corner of the mouth may be compared to the location of the left corner of the mouth, with respect to the axis of symmetry 340, to identify a degree of asymmetry associated with the right and left corners of the mouth.

FIGS. 6E-6G illustrate an exemplary process for generating an individualized cosmetic instruction, in accordance with various aspects of the subject technology. Referring to FIG. 6E, a datum line 352A is overlaid to identify a degree of asymmetry associated with a particular facial feature 311. As shown, reference line 322A extending between reference points 312A, B associated with the user's 260 eyebrows is not aligned with the datum line 352A, thereby demonstrating that the eyebrows are not symmetrical about the axis of symmetry 340. In one aspect, symmetry of the facial features 311 may also be assessed by comparing a level of parallelism between the reference lines 322A-N. Where a particular reference line, such as reference line 322A, appears skewed when compared to other reference lines 322B-D (shown in FIG. 6B), or not substantially parallel with the other reference lines 322B-D, the corresponding facial feature may be denoted as being asymmetrical requiring appropriate adjustment of the cosmetic treatment plan in order to achieve an ideal cosmetic application as discussed below with reference to FIGS. 6F and 6G.

Referring to FIG. 6F, an individualized cosmetic instruction is generated based on the symmetry of the facial features 311 of the user 260. Continuing with the example outlined above regarding asymmetrical eyebrows, the processor generates a cosmetic instruction for application of eyeshadow. For the right eye and eyebrow, a first cosmetic instruction 362A is generated that comprises an outline having a shape, as well as a shade, for an eyeshadow application. For the left eye, a second cosmetic instruction 362B is generated that is individually customized based on the user's facial features 311, and specifically, based on the asymmetry of the eyebrows. As shown in FIG. 6F, an outline of the second cosmetic instruction 362B is not simply a mirrored outline of the first cosmetic instruction 362A. Instead, the outline (and shape) of the second cosmetic instruction 362B is derived by considering a spacing of other facial features of the user's 260 face, such as a distance 370 between the eyebrows and eyes. Because the left eyebrow is higher than the right eyebrow, the outline of the second cosmetic instruction 362B occupies more area of the skin than the first cosmetic instruction 362A in order to maintain a distance 370 between the left eyebrow and the left eye that is similar to a distance 370 between the right eyebrow and the right eye. By doing so, application of the eyeshadow consistent with the first cosmetic instruction 362A and the second cosmetic instruction 362B results in a balancing of the eyeshadow over the right and left eyes.

To better illustrate the individualized cosmetic instruction generated by the processor, a mirrored representation 362C of the first cosmetic instruction 362A is shown over the second cosmetic instruction 362B. Use of the mirrored representation 362C to apply eyeshadow would result in a larger gap or distance between the left eyebrow and left eye when compared to the distance between the right eyebrow and right eye. As a result, such a cosmetic application would enhance the asymmetry of the eyebrows, rather than conceal it resulting in an undesirable application of the eyeshadow. The second cosmetic instruction 362B therefore represents a modified outline having a shape that is customized based on the individual characteristics of a user's 260 facial features 311.

Referring to FIG. 6G, another example of individualized cosmetic instructions are shown based on the symmetry of the facial features 311 of the user 260. In this example, the user's 260 facial features include asymmetrical eyebrows and eyes. A datum line 352B is overlaid to identify a degree of asymmetry associated with the eyes. As shown, reference line 322B extending between reference points 312C, D associated with the user's 260 eyes is not aligned with the datum line 352B, thereby demonstrating that the eyes are not symmetrical about the axis of symmetry 340. The asymmetrical eyebrows and eyes require appropriate adjustment of a cosmetic treatment plan in order to achieve an ideal cosmetic application.

Specifically, two individualized cosmetic instructions are generated based on the symmetry (or asymmetry) of the facial features 311 of the user 260. For the right eye and eyebrow, the processor generates a third cosmetic instruction 362D that is individually customized based on the user's facial features 311, and specifically, based on the asymmetry of the eyebrows and eyes. For the left eye, a fourth cosmetic instruction 362E is generated that is individually customized based on the user's facial features 311, and specifically, based on the asymmetry of the eyebrows and eyes. As shown in FIG. 6G, an outline of the fourth cosmetic instruction 362E is not simply a mirrored outline of the third cosmetic instruction 362D. Instead, both are uniquely shaped in order to address the asymmetrical facial features 311 of the user 260.

In one example, the outline (and shape) of the third cosmetic instruction 362D and the fourth cosmetic instruction 362E are derived by considering a spacing of other facial features of the user's 260 face, such as a distance 370 between the eyebrows and eyes. Because the left eyebrow is higher than the right eyebrow, and the left eye is lower than the right eye, the outline of the fourth cosmetic instruction 362E occupies more area of the skin than the third cosmetic instruction 362D in order to maintain a distance 370 between the left eyebrow and the left eye that is similar to a distance 370 between the right eyebrow and the right eye. By doing so, application of the eyeshadow consistent with the third cosmetic instruction 362D and the fourth cosmetic instruction 362E results in a balancing of the eyeshadow over the right and left eyes.

To better illustrate the individualized cosmetic instructions generated by the processor, the first cosmetic instruction 362A and the mirrored representation 362C are shown in FIG. 6G to demonstrate the magnitude of the alterations to the outline and shape of the third and fourth cosmetic instructions, 362D and 362E respectively. If the eyeshadow outlines remained unaltered, eyeshadow application would result in large gaps between the eyebrows and eyes on one side, versus the other, thereby exacerbating the asymmetrical facial features 311 of the user 260. The third and fourth cosmetic instructions, 362D and 362E respectively, therefore represent modified outlines having unique shapes that are customized based on the individual characteristics of a user's 260 facial features 311 to better conceal asymmetrical features and improve application of cosmetics.

FIGS. 7A and 7B illustrate exemplary cosmetic routine templates that may be utilized to generate an individualized cosmetic program, in accordance with various aspects of the subject technology. A user 260 may select a particular cosmetic routine, skin care routine, or health screening routine from a plurality of available routines, as desired. For example, a user 260 may browse available cosmetic routines, identify those that the user may deem interesting for previewing, and if desired, may further select a routine for use. The cosmetic routines may be accompanied by instructional tutorials (as shown in FIGS. 8A-8G) that may be hosted by notable makeup artists or influencers, and may provide a user with a wide variety of tutorials ranging from holiday themes (e.g., Christmas, Halloween, etc.), glam, specialty looks, as well as everyday looks.

In use, the smart mirror 100 may be configured to allow users to create a user account and profile, bookmark favorites, maintain a history of attempted cosmetic or skincare routines, and through a network connection, share previews or finished applications on social media and purchase products through online marketplaces or subscribe to subscription boxes that correspond to a particular cosmetic or skincare routine. In addition, the smart mirror 100 may feature certain cosmetic or skin care routines that are specifically targeted to a particular user's preferences, features, or interests.

The user may browse routines using the display and provide a selection using an input device, such as a mouse, touchscreen, or other devices that are configured to receive user input as would be understood by a person of ordinary skill in the art. Upon initial selection, the smart mirror 100 may provide a preview of the selected routine by augmenting a reflection of the user 260 using the display 115 (not shown) to generate renderings of the cosmetic application onto the reflection of the user 260. In another example, the smart mirror 100 may provide a preview of the selected routine by rendering the cosmetic application into a live video of the user 260 using the display 115 (not shown).

The preview renderings of the cosmetic application may include application of concealer, highlighter, contour, blush, bronzer, eyeliner, types and shapes of artificial eyelashes, lipliner, lipsticks, mascara, foundation, powder, and/or eyeshadow. In a first example, as shown in FIG. 7A, the preview renderings include a rendering of eyeshadow 372A for a right eye, a rendering of eyeshadow 372B for a left eye, and a rendering of lipliner 374 surrounding a mouth of the user 260. As another example, as shown in FIG. 7B, a different cosmetic routine may be selected by the user 260 resulting in different preview renderings being displayed. The renderings illustrated in FIG. 7B are thus different in outline and shape from the renderings illustrated in FIG. 7A. The preview renderings illustrated in FIG. 7B include a rendering of eyeshadow 372A for a right eye, a rendering of eyeshadow 372B for a left eye, a rendering of lipliner 374 surrounding a mouth of the user 260, a rendering of blush for a right cheek 376A, and a rendering of blush for a left cheek 376B.

As described above, the smart mirror 100 uses the image capture device 120 to scan the facial features of the user 260 to assess a symmetry of the facial features, and scans the skin condition 310 of the user 260 to assess skin tone, color or disorder. Light 130 may be adjusted as needed to ensure accurate capture of the facial features and skin condition. Using the image data captured by the image capture device 120, the preview renderings are mapped to the appropriate facial features (utilizing, for example, reference points 312A-N) to ensure accurate depiction of the renderings onto the user's face. In addition, by continually monitoring and tracking movement of the user's head in real time using the image capture device 120 and the processor, the preview renderings may be configured to dynamically track the user's movement in real-time so that they appear accurate from the perspective of the user 260.

FIGS. 8A-8G illustrate an exemplary process for applying an individualized cosmetic program using an intelligent feedback system, in accordance with various aspects of the subject technology. Referring to FIG. 8A, the smart mirror 100 provides a display layout 200 that includes the primary region 220 and the secondary region 210. The secondary region 210 displays a video tutorial 250 and the primary region 220 displays the user 260. Upon selection of a particular cosmetic or skincare routine by the user for application, the processor generates an individualized cosmetic treatment program based on the symmetry of the facial features 311 (e.g., eye, nose, eyebrow, cheek, mouth, etc.) of the user 260 and/or the skin condition 310 of the user 260, as discussed above.

In one aspect, the cosmetic treatment program is parsed into a plurality of segments to enable the user to complete a first segment, prior to embarking on a next segment. By parsing the cosmetic treatment program into separate segments, successful application of the cosmetic material is improved because the system is able to confirm successful completion of a particular segment before continuing on to the next segment. For example, a cosmetic treatment program may involve the application of eyeshadow, blush, and lipliner. By segmenting the cosmetic treatment program into segments (e.g., a first segment for a right eyeshadow application, a second segment for a left eyeshadow application, a third segment for a right cheek blush application, a fourth segment for a left cheek blush application, and a fifth segment for a lipliner application), the user is encouraged to focus on a single segment at a time, and to only proceed to a subsequent segment when the current segment is successfully completed.

To enable monitoring of progression through a particular segment, cosmetic instructions may be generated that correspond to a particular segment. For example, a first segment relating to application of eyeshadow onto a right eye, may cause a first cosmetic instruction 362A to be generated that comprises an outline delineating an area for application of the eyeshadow and/or a color indicating a shade for the eyeshadow. A second segment relating to application of eyeshadow onto a left eye, may cause a second cosmetic instruction 362B to be generated that comprises an outline delineating an area for application of the eyeshadow and/or a color indicating a shade for the eyeshadow. A third segment relating to application of blush onto a right cheek, may cause a third cosmetic instruction 362D to be generated that comprises an outline delineating an area for application of the blush and/or a color indicating a shade for the blush. A fourth segment relating to application of blush onto a left cheek, may cause a fourth cosmetic instruction 362E to be generated that comprises an outline delineating an area for application of the blush and/or a color indicating a shade for the blush. A fifth segment relating to application of lipliner, may cause a fifth cosmetic instruction 362F to be generated that comprises an outline delineating an area for application of the lipliner.

As shown in FIG. 8A, the outlines of the first, second, third, fourth, and fifth cosmetic instructions, 362A, B, and D-F respectively, are displayed in the primary region 220 of the smart mirror 100 to augment a reflection of the user 260. In one aspect, the plurality of reference points 312A-N may be utilized to assist in accurately placing, locating, and manipulating (e.g., deforming based on head movement) the cosmetic instructions onto the reflection of the user 260 (as shown in FIGS. 8B-8C). As shown in FIG. 8A, the outline of the second cosmetic instruction 362B aids the user 260 in applying the cosmetic material 410 (e.g., eyeshadow) onto a first area of the face of the user 260.

In some aspects, each cosmetic instruction may be accompanied by a tutorial video 250, that instructs the user 260 on how to apply the corresponding cosmetic material, thereby further aiding the user 260 in applying the cosmetic material 410 properly.

FIG. 8B illustrates a detailed view of a first rendering of the second cosmetic instruction 362B, in accordance with various aspects of the subject technology. The second cosmetic instruction 362B may include one or more outlines, shapes, colors, and/or shading for instructing the user on how to apply the cosmetic material onto the skin of the user. For example, the second cosmetic instruction 362B may include a first outline 363A filled in with a shade of a color denoting an area to apply the cosmetic material. The first outline 363A may have a plurality of outlines overlaid thereon indicating areas to apply different colors. For example, a second outline 363B may be disposed proximate to the eyebrow to highlight the brow bone of the user. A third outline 363C may be disposed below the bone brow, just above the eye crease, denoting an area for application of a different shade or color. A fourth outline 363D may be disposed at the eye crease denoting an area for application of a different shade or color. The second cosmetic instruction 362B may further include a fifth outline 363E denoting an inner corner of the eye, proximate to the tearduct, for application of a particular color or shade. The second cosmetic instruction 362B may also include one or more outlines delineating a shade or color for the inner eyelid, middle of the eyelid, and/or the outer corner of the eyelid. For example, the second cosmetic instruction 362B may include a sixth outline 363F, seventh outline 363G, and an eighth outline 363H denoting areas on the eyelid for application of cosmetic material with different shades or colors. Each of the outlines 363A-H may be located and rendered using one or more of the plurality of reference points 312A, B, recognition of facial features of the user, or through other image processing methods as would be known by a person of ordinary skill in the art.

FIG. 8C illustrates a detailed view of a second rendering of the second cosmetic instruction 362B, in accordance with various aspects of the subject technology. In one aspect of the subject technology, as the user moves or changes an orientation of their body, image data is continually processed to render, re-render, or modify rendering of the outlines and/or shapes of the cosmetic instructions, and their placement onto the user's body, to ensure accurate placement of the cosmetic instructions onto the user's body. For example, if the user turns their head and changes the orientation of their face with respect to the system, the system modifies the renders of the second cosmetic instruction 362B such that they appears accurate in terms of orientation and location from the perspective of the user. As shown, as a result of the user turning their head, the outlines 363A-H are rendered with modified outlines and shapes to accurately map onto the face of the user. Here, for example, the first outline 363A has a different outline and shape when compared to the outline and shape shown in FIG. 8B. Similarly, the second outline 363B, third outline 363C, fourth outline 363D, seventh outline 363G, and eighth outline 363H have different outlines and shapes when compared to the outlines and shapes shown in FIG. 8B. As also shown, certain outlines, such as the fifth outline 363E and the sixth outline 363F are not rendered because they are out of view from the perspective of the user.

Referring to FIG. 8D, as the user 260 proceeds through a particular segment, the smart mirror 100 is configured to monitor application of the cosmetic material 410 via the image capture device 120 and the processor, to ensure that the user 260 is properly applying the cosmetic material 410 according to the corresponding cosmetic instruction. Should misapplication of the cosmetic material 410 be detected, the processor may be further configured to provide an intervention to alter the application of the cosmetic material 410. For example, the processor may cause the smart mirror 100 to emit an auditory tone, auditory message, video, image and/or textual message informing the user that misapplication has been detected and provide remedial recommendations for correcting the misapplication of the cosmetic material 410. Such intervention may, for example, involve a prompt, animation, or other visual queue that informs the user of the misapplication. In this example, the display 115 (as shown in FIG. 2) would be utilized to display the prompt, animation, or visual queue. Should an auditory message be used, the speaker 168 (shown in FIG. 2) may be utilized to play a message, tone or alarm.

Referring to FIG. 8D, in some aspects, as the user applies the cosmetic material 410, the processor may cause the display to continue to render the second cosmetic instruction 362B to ensure that the user 260 is able to complete the appropriate segment of the individualized cosmetic treatment program in an assisted manner. In other aspects, the processor may cause certain elements of the cosmetic instructions to be removed to enable the user 260 to better inspect their progress in applying the cosmetic material 410. For example, where the cosmetic instruction 362A-F includes and outline and a color or shade, the processor may stop rendering all or a portion of the color or shade as the user fills the outline with the cosmetic material 410 to ensure that the user is aware of the actual application of the cosmetic material (versus the virtually rendered application). In this example, however, the outline would remain to assist the user in applying the cosmetic material 410.

Referring to FIG. 8E, in other aspects, as a segment is completed and a subsequent segment is undertaken, the cosmetic instructions corresponding to the completed segment may be removed from the from the display layout 200. For example, as the user 260 completes the second cosmetic instruction 362B, the outline corresponding to the second cosmetic instruction 362B is removed from the display layout 200. As such, the processor is configured to modify the display layout 200 as the user 260 progresses through the plurality of segments of the individualized cosmetic treatment program. By not rendering the completed second cosmetic instruction 362B, the user can easily distinguish between areas of the skin that have actual cosmetic material applied thereon, and those areas that do not. In other aspects, the user 260 may remove some or all renderings of the cosmetic instructions, as desired, intermittently, by simply making the appropriate selection (e.g., touch button) on the touch interface to stop the rendering, or by otherwise providing the appropriate input to the smart mirror 100 or other applicable device.

Referring to FIG. 8F, upon completion of the individualized cosmetic treatment program and thus, of all the corresponding segments, the smart mirror 100 may remove all renderings from the display layout 200 leaving an undisturbed or un-augmented reflection of the user 260 on the mirror 110. As such, what is shown to the user 260 is the cosmetic material 410 properly applied onto the skin and face of the user 260. In some aspect, once completed, the system may compute an accuracy score reflecting an accuracy of application of the cosmetic material onto the user's face. Improvements in application and skill may then be realized and appreciated by comparing current scores with previous scores.

FIG. 8G illustrates an exemplary graphical user interface for displaying a video tutorial 250, in accordance with various aspects of the subject technology. The video tutorial 250 may comprise a player 510 that is configured to enhance instruction by allowing a user to easily control playback progress of video segments at the user's direction via the use of looping video segments that advance to subsequent segments upon receipt of user input. Video segments 530A-E may correspond to parsed segments of the cosmetic treatment program discussed above. Specifically, the player 510 includes a timeline 520 that depicts video segments 530A-E denoted by segment breaks 540. Each video segment 530A-E is configured to loop 545 until the user presses or touches an advance button 560. Upon receipt of user input from activation of the advance button 560, the next video segment 530A-E begins to play and loop 545. The player 500 also includes a skip button 550B to advance to a subsequent video segment and a back button 500A to view prior video segments. By looping video segments 530A-E, a user is able to accomplish each task before proceeding to the next video segment. In this way, instruction is improved by allowing the user to view the same instructional step as many times as necessary for the user to accomplish the relevant task. The instructional step is presented to the user and looped without necessitating the user to press any button or otherwise interact with the player, thereby improving the instructional experience.

The player 510 also includes a playback speed button 570 that enables the user to alter the playback speed to increase or slow playback. In one aspect, with each successive video segment loop, the playback speed may be adjusted automatically to a slower speed to enable the user to better receive the instructional step. The playback speed can be slowed up to a certain threshold where thereafter, the slowed playback speed is maintained until the user otherwise adjusts the speed or proceeds to the next step. For example, video segment 530B may play a 1× speed and upon the first loop be slowed to 0.8× speed. Upon the second loop, video segment 530B may be further slowed to 0.5× speed. Upon the third loop, video segment 530B may be maintained at 0.5× speed for the remaining loops unless the user alters the playback speed or advances to the next video segment 530C.

It is understood that player 510 may be utilized for the video tutorial 250 displayed on smart mirror 100, or a portable electronic device such as a mobile device. In instances where the video player 510 is displayed on a mobile device, the player 510 may also include a cast button 580 to enable casting of the video player on other devices, such as the smart mirror 100.

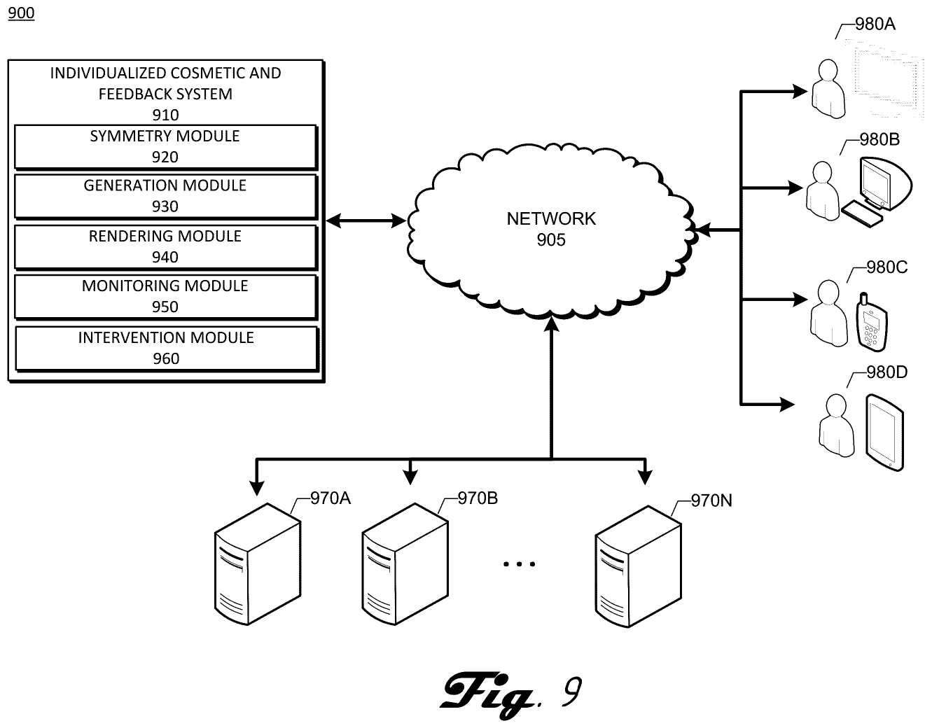

FIG. 9 illustrates an example network environment 900 utilizing an individualized cosmetic and intelligent feedback system 910, in accordance with various aspects of the subject technology. The individualized cosmetic and intelligent feedback system 910 is connected to a plurality of user devices 980A-D that are configured to capture image date of facial features of the user, such as smart mirror 980A, computer with webcam 980B, mobile device with camera 980C, and tablet with camera 980D. In one aspect, the individualized cosmetic and intelligent feedback system 910 may utilize a display, speaker, processor, camera, and/or input device of a user device 980A-D to perform one or more functions of the individualized cosmetic and intelligent feedback system 910.

In addition, the individualized cosmetic and intelligent feedback system 910 may also be connected to one or more social media platforms or marketplaces (e.g., ecommerce) 970A-N via a network 905. User devices 980A-D may access the individualized cosmetic and intelligent feedback system 910 directly via the network 905. The individualized cosmetic and intelligent feedback system 910 includes one or more machine-readable instructions, which may include one or more of a symmetry module 920, generation module 930, rendering module 940, monitoring module 950, and intervention module 960. In one aspect, the individualized cosmetic and intelligent feedback system 910 may comprise one or more servers connected via the network 905. In some example aspects, the individualized cosmetic and intelligent feedback system 910 can be a single computing device or in other embodiments, the individualized cosmetic and intelligent feedback system 910 can represent more than one computing device working together (e.g., in a cloud computing configuration).

The network 905 can include, for example, one or more cellular networks, a satellite network, a personal area network (PAN), a local area network (LAN), a wide area network (WAN), a broadband network (BBN), and/or a network of networks, such as the Internet, etc. Further, the network 905 can include, but is not limited to, any one or more of the following network topologies, including a bus network, a star network, a ring network, a mesh network, a star-bus network, tree or hierarchical network, and the like.

The individualized cosmetic and intelligent feedback system 910 includes at least one processor, a memory, and communications capability for receiving image data from the plurality of user devices 980A-D and for providing an individualized cosmetic treatment program based on facial features and skin conditions of the user. The individualized cosmetic and intelligent feedback system 910 includes the symmetry module 920. The symmetry module 920 is configured to assess a symmetry of facial features (e.g., eyebrows, eyes, nose, mouth, cheeks, etc.) and skin conditions of a user by analyzing images of the user.

The individualized cosmetic and intelligent feedback system 910 also includes the generation module 930. The generation module 930 generates an individualized cosmetic treatment program based on the symmetry of the facial features and/or the skin conditions of the user. The generation module 930 may also parse the individualized cosmetic treatment program into a plurality of segments. The generation module 930 may also generate a cosmetic instruction for each segment. The segments may be configured to be completed or displayed in a sequential order. The generated cosmetic instructions may comprise cosmetic instruction comprise an outline delineating an area for application of the cosmetic material and/or a color indicating a shade for application of the cosmetic material. In addition, the generation module 930 may also associate a tutorial video for each cosmetic instruction to aid a user in successfully applying a cosmetic material.

The individualized cosmetic and intelligent feedback system 910 also includes the rendering module 940. The rendering module 940 renders for display the generated cosmetic instructions in order to aid a user in successfully applying a cosmetic material. The rendering module 940 may also modify rendered elements corresponding to the cosmetic instructions as a user progresses through segments of the individualized cosmetic treatment program. In addition, the rendering module 940 may also alter a shape and/or location of rendered elements based on detected motion or movement of a user's body or head so that placement of the rendered elements onto a user's body or head remain accurate and realistic, and therefore helpful in aiding the user in applying the cosmetic material. In other words, the rendering module 940 is configured to render in real-time, the cosmetic instructions onto a display or augmented reflection of the user in order to aid the user in applying cosmetics. In one aspect, the rendering module 940 may also render elements corresponding to the segments of the individualized cosmetic treatment program in a particular order, such as in a sequential order.

The individualized cosmetic and intelligent feedback system 910 also includes the monitoring module 950. The monitoring module 950 receives image data and processes the image data to detect whether the user has misapplied cosmetic material according to the cosmetic instructions. The monitoring module 950 may analyze incoming image data and compare the image data to the cosmetic instructions to confirm whether the user is applying cosmetic material outside of defined outlines or boundaries, or applying cosmetic material in a manner that is inconsistent with color schemes or shades that are identified for a particular cosmetic program.

The individualized cosmetic and intelligent feedback system 910 also includes the intervention module 960. The intervention module 960 provides an intervention to alter the application of the cosmetic material in response to a detected misapplication of the cosmetic material. The intervention may include an auditory tone, auditory message, video, image or textual message.

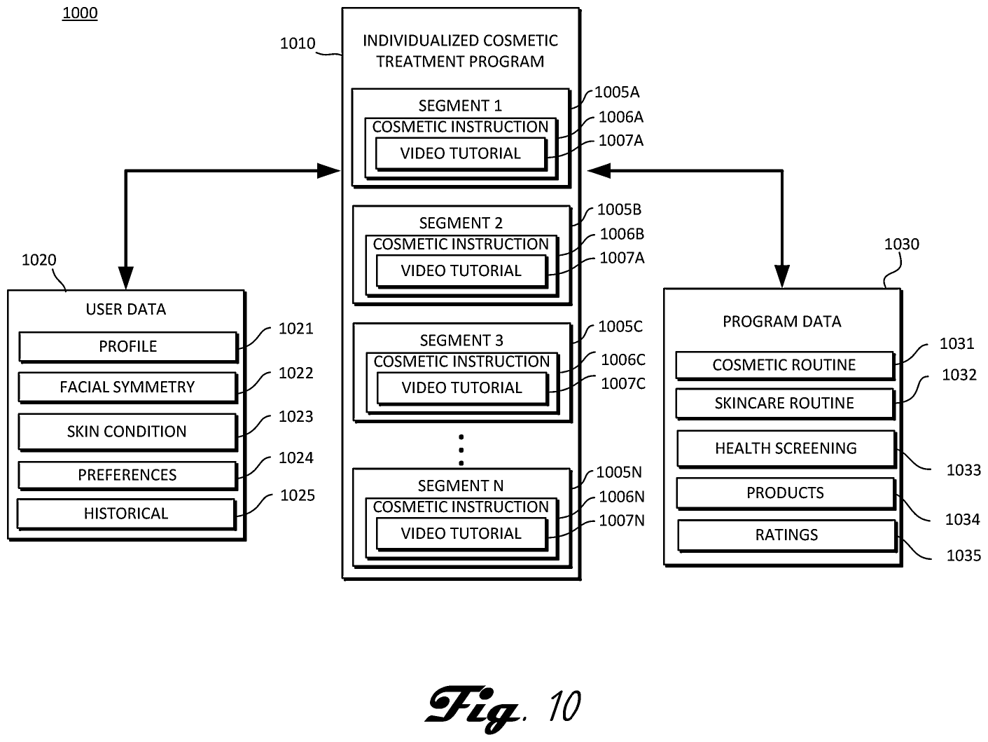

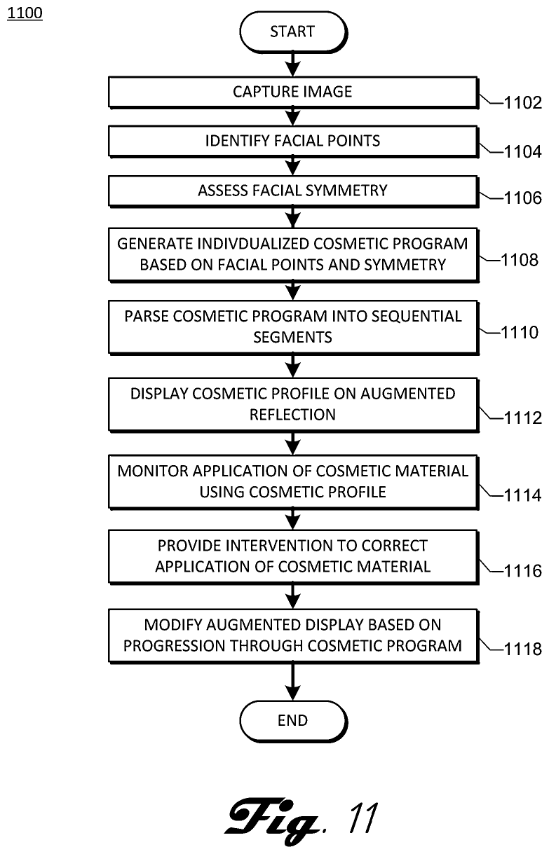

FIG. 10 illustrates a conceptual block diagram 1000 of data structures utilized in an individualized cosmetic and intelligent feedback system, in accordance with various aspects of the subject technology. The individualized cosmetic and intelligent feedback system generates individualized cosmetic treatment programs 1010 and includes at least one processor, a memory, and communications capability for receiving user data 1020 and program data 1030.

In operation, the individualized cosmetic and intelligent feedback system receives user data 1020 and program data 1030 to generate individualized cosmetic treatment programs 1010. In one example, user data 1020 includes a user's profile 1021 (e.g., name, username, user identifier, email, social media accounts, gender, ethnicity, age, etc.); facial symmetry 1022 of the user; skin condition 1023 of the user; preferences 1024 of the user (e.g., style preferences, favorite looks, favorite artists, bookmarked routines, etc.); historical 1025 information regarding the user's activity on the system (e.g., prior routines, prior selections, prior feedback or reviews, etc.). The user data 1020 may be encrypted or otherwise protected from exposure to protect sensitive information, such as names, addresses, and personal identifying information.

Program data 1030, in one example, may include cosmetic routines 1031; skincare routines 1032; health screenings 1033 (e.g., analysis of moles, rashes, etc.); products 1034 (e.g., identification of products used in a particular routine, product purchase information, etc.); and ratings 1035 (e.g., user reviews relating to a particular routine).

The individualized cosmetic treatment program 1010 includes a plurality of segments 1005A-N. Each segment 1005A-N includes a cosmetic instruction 1006A-N (e.g., outline, shade of color, color, etc.). Each cosmetic instruction 1006A-N includes a corresponding video tutorial 1007A-N to aid the user in applying a cosmetic material.

In operation, a user may create an account and user profile. A scan of the user's facial features is performed to assess a symmetry of the facial features and skin condition of the user. The user may then select a particular cosmetic routine, skin care routine, or health screening routine from a plurality of available routines, as desired. For example, for a skincare routine, the individualized cosmetic treatment program 1010 will identify a toner, moisturizer, and/or serum that is specifically tailored for the user's particular skin condition (e.g., wrinkles, dark spots, etc.).

For a cosmetic routine, the individualized cosmetic treatment program 1010 generates segments necessary for achieving a desired final result, from beginning to end. Cosmetic routines may include routines for everyday looks, holiday looks (e.g., Christmas, Valentines, New Year's Eve, Halloween), special occasions (e.g., weddings, brides, bridesmaids, etc.), celebrity artist tutorials, and may also include routines intended for a particular area of interest, such as routines directed to a particular style of eyeshadow, eyebrows, eyeliner, lashes, contouring, highlighting, baking, cheeks, foundation, concealer, and/or setting.

For a health screening routine, the individualized cosmetic treatment program 1010 will alert the user as to any changes in the skin, such as new fine lines, moles that have changed in size or color, or growths in the face and neck. For minor changes in the skin, the individualized cosmetic treatment program 1010 may recommend a revised or updated skincare regimen and will further track progress over time to ensure that the recommended actions are effective.

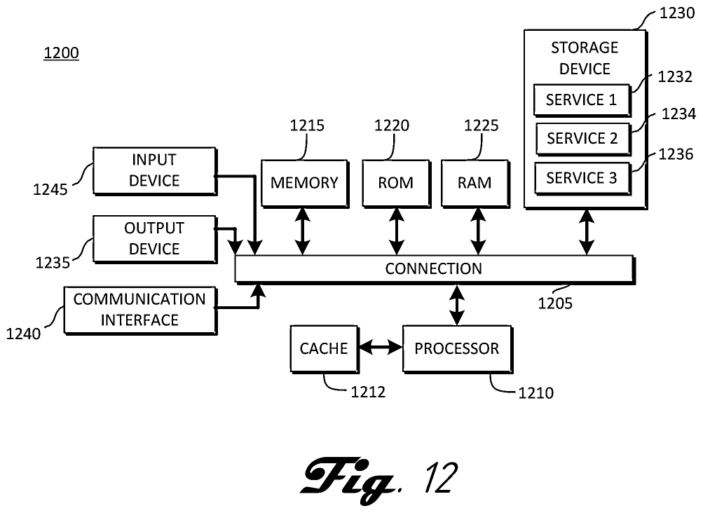

FIG. 11 illustrates an example method 1100 for generating an individualized cosmetic program, in accordance with various aspects of the subject technology. It should be understood that, for any process discussed herein, there can be additional, fewer, or alternative steps performed in similar or alternative orders, or in parallel, within the scope of the various aspects unless otherwise stated. The method 1100 can be performed by a smart mirror 100 (as shown in FIGS. 1-8G) or by individualized cosmetic and intelligent feedback system 910 (as shown in FIG. 9).

At operation 1102, an image of a user is captured, the image includes facial features of the user. Facial features may include eyebrows, eyes, nose, mouth, and cheek. The method 1100 may also include adjusting a color temperature and intensity of an emitted light based on a color temperature or intensity of ambient light to improve a quality of image capture of the user.

At operation 1104, the image is analyzed to identify a plurality of reference points corresponding to the facial features of the user. In some aspects, the image may be analyzed identify a skin condition of the user (e.g., color, tone, disorder, etc.). At operation 1106, a symmetry of the facial features of the user is assessed using the plurality of reference points.

At operation 1108, an individualized cosmetic treatment program is generated based on the symmetry of the facial features. In some aspects, the individualized cosmetic treatment program may be further generated based on the identified skin condition. The method 1100 may also include receiving a selection from the user of a desired cosmetic routine, skin care routine, or health screening routine, prior to generating the individualized cosmetic treatment program.

At operation 1110, the individualized cosmetic treatment program may be parsed into a plurality of segments. Cosmetic instructions corresponding to each segment of the plurality of segments are generated. The cosmetic instructions aid the user in applying a cosmetic material onto areas of a face of the user. For example, the cosmetic instructions may include an outline delineating an area for application of the cosmetic material and/or a color indicating a shade for application of the cosmetic material. In one aspect, the plurality of segments may be configured to be displayed or presented in a sequential order.

At operation 1112, a first cosmetic instruction based on the individualized cosmetic treatment program is displayed. A tutorial video corresponding to the first cosmetic instruction may also be displayed to further aid the user in applying the cosmetic material. In one example, the first cosmetic instruction may be displayed in an augmented image or video of the user. In another example, the first cosmetic instruction may be displayed in an augmented reflection of the user.

At operation 1114, application of the cosmetic material is monitored based on the first cosmetic instruction to detect a misapplication of the cosmetic material. At operation 1116, a first intervention is provided to alter the application of the cosmetic material in response to a detected misapplication of the cosmetic material. The intervention may include an auditory tone, auditory message, video, image or textual message. At operation 1118, the display of the first cosmetic instruction may be modified as the user progresses through the first segment of the plurality of segments.

The method 1100 may further include displaying a second cosmetic instruction corresponding to a second segment of the plurality of segments. The second cosmetic instruction is configured to aid the user in applying the cosmetic material onto a second area of the face of the user. The method 1100 may also include monitoring application of the cosmetic material based on the second cosmetic instruction to detect a misapplication of the cosmetic material, and providing a second intervention to alter the application of the cosmetic material in response to a detected misapplication of the cosmetic material. The method 1100 may also include modifying the display of the second cosmetic instruction as the user progresses through the second segment of the plurality of segments. The method 1100 may also include communicating with a mobile device to convey at least one of a cosmetic recommendation or cosmetic application reminder to the user.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

FIG. 12 illustrates an example of a system 1200 configured for generating an individualized cosmetic program, in accordance with various aspects of the subject technology. A system which some implementations of the subject technology are implemented may include various types of computer readable media and interfaces for various other types of computer readable media. One or more components of the platform are in communication with each other using connection 1205. Connection 1205 can be a physical connection via a bus, or a direct connection into processor 1210, such as in a chipset architecture. Connection 1205 can also be a virtual connection, networked connection, or logical connection.

In some embodiments system 1200 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

System 1200 includes at least one processing unit (CPU or processor) 1210 and connection 1205 that couples various system components including system memory 1215, such as read only memory (ROM) 1220 and random access memory (RAM) 1225 to processor 1210. Computing system 1200 can include a cache 1212 of high-speed memory connected directly with, in close proximity to, or integrated as part of processor 1210.

Connection 1205 also couples smart mirrors to a network through the communication interface 1240. In this manner, the smart mirrors can be a part of a network of computers (such as a local area network (“LAN”), a wide area network (“WAN”), or an Intranet, or a network of networks, such as the Internet.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms known to those of skill in the art, and may include, for example, printers and display devices, such as cathode ray tubes (CRT) or liquid crystal displays (LCD). Some implementations include devices such as a touch screen that functions as both input and output devices. In some instances, multimodal systems can enable a user to provide multiple types of input/output to communicate with computing system 1200. Computing system 1200 can include communications interface 1240, which can generally govern and manage the user input and system output. There is no restriction on operating on any particular hardware arrangement and therefore the basic features here may easily be substituted for improved hardware or firmware arrangements as they are developed.

Storage device 1230 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 1230 can include software services, servers, services, etc., that when the code that defines such software is executed by the processor 1210, it causes the system to perform a function. In some embodiments, a hardware service that performs a particular function can include the software component stored in a computer-readable medium in connection with the necessary hardware components, such as processor 1210, connection 1205, output device 1235, etc., to carry out the function.

It will be appreciated that computing system 1200 can have more than one processor 1210, or be part of a group or cluster of computing devices networked together to provide greater processing capability.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A method for playing a video tutorial, the method comprising:
at an electronic device with one or more processors and memory, wherein the device is in communication with a display
providing, to the display, data to present a video tutorial, the video tutorial comprising a plurality of segments;
automatically looping a first video segment;
during playback of the first video segment, receiving input that corresponds to a request to display a second video segment; and
in response to receiving the input that corresponds to the request to display the second video segment, automatically looping the second video segment.

2. The method of claim 1, further comprising automatically altering a playback speed of the first video upon each successive loop.

3. The method of claim 2, further comprising altering the playback speed upon each successive loop until a predetermined minimum playback speed is achieved.

4. The method of claim 1, further comprising during playback of the second video segment, receiving input that corresponds to a request to display a third video segment and in response to receiving the input that corresponds to the request to display the third video segment, automatically looping the third video segment.

5. The method of claim 1, wherein the video tutorial comprises an individualized cosmetic treatment program.

6. The method of claim 5, wherein the individualized cosmetic treatment program is based on a symmetry of facial features of a user.

7. The method of claim 1, wherein the first video segment is configured to aid a user in applying a cosmetic material onto a first area of a face of the user.

8. The method of claim 8, wherein the second video segment is configured to aid a user in applying a cosmetic material onto a second area of a face of the user.

9. The method of claim 1, wherein the video tutorial comprises a cosmetic application.

10. An electronic device that is in communication with a display, the device comprising:
one or more processors; and
memory storing one or more programs for execution by the one or more processors, the one or more programs including instructions for:
providing, to the display, data to present a video tutorial, the video tutorial comprising a plurality of segments;
automatically looping a first video segment;
during playback of the first video segment, receiving input that corresponds to a request to display a second video segment; and
in response to receiving the input that corresponds to the request to display the second video segment, automatically looping the second video segment.

11. The electronic device of claim 10, wherein the one or more programs include instructions for automatically altering a playback speed of the first video upon each successive loop.

12. The electronic device of claim 11, wherein the one or more programs include instructions for altering the playback speed upon each successive loop until a predetermined minimum playback speed is achieved.

13. The electronic device of claim 10, wherein the one or more programs include instructions for, during playback of the second video segment, receiving input that corresponds to a request to display a third video segment and in response to receiving the input that corresponds to the request to display the third video segment, automatically looping the third video segment.

14. The electronic device of claim 10, wherein the video tutorial comprises an individualized cosmetic treatment program.

15. The electronic device of claim 14, wherein the individualized cosmetic treatment program is based on a symmetry of facial features of a user.

16. The electronic device of claim 10, wherein the video tutorial comprises a cosmetic application.

17. A non-transitory computer readable storage medium storing one or more programs, the one or more programs comprising instructions, which, when executed by an electronic device that is in communication with a display, cause the device to:
provide, to the display, data to present a video tutorial, the video tutorial comprising a plurality of segments;
automatically loop a first video segment;
during playback of the first video segment, receive input that corresponds to a request to display a second video segment; and
in response to receiving the input that corresponds to the request to display the second video segment, automatically loop the second video segment.

18. The non-transitory computer readable storage medium of claim 17, wherein the one or more programs include instructions, which when executed by the electronic device, cause the electronic device to automatically alter a playback speed of the first video upon each successive loop.

19. The non-transitory computer readable storage medium of claim 17, wherein the one or more programs include instructions, which when executed by the electronic device, cause the electronic device to alter the playback speed upon each successive loop until a predetermined minimum playback speed is achieved.

20. The non-transitory computer readable storage medium of claim 17, wherein the one or more programs include instructions, which when executed by the electronic device, cause the electronic device to, during playback of the second video segment, receive input that corresponds to a request to display a third video segment and in response to receiving the input that corresponds to the request to display the third video segment, automatically loop the third video segment.
